(19) United States
(12) Patent Application Publication
(10) Pub. No.: US 2025/0294413 A1
(43) Pub. Date: Sep. 18, 2025

(54) Assistance Information for Mobility Prediction

(71) Applicant: QUALCOMM Incorporated, San Diego, CA (US)

(72) Inventors: Rajeev KUMAR, San Diego, CA (US); Shankar KRISHNAN, San Diego, CA (US); Geetha Priya RAJENDRAN, Bangalore (IN); Aziz GHOLMIEH, Del Mar, CA (US); Punyaslok PURKAYASTHA, San Diego, CA (US); Ozcan OZTURK, San Diego, CA (US); Prasad Reddy KADIRI, San Diego, CA (US)

(21) Appl. No.: 18/604,245

(22) Filed: Mar. 13, 2024

(51) Int. Cl. H04W 36/00; H04W 36/30

(52) U.S. Cl. CPC H04W 36/0061; H04W 36/0079; H04W 36/00835; H04W 36/305

(57) ABSTRACT

Certain aspects of the present disclosure provide techniques for mobility prediction with assistance information. An example method for wireless communications includes obtaining assistance information associated with user equipment (UE) mobility; predicting one or more candidate communication links for a communication link modification based at least in part on the assistance information; and communicating with a wireless communications device based at least in part on the one or more candidate communication links.

### FIELD OF THE DISCLOSURE

Aspects of the present disclosure relate to wireless communications, and more particularly, to techniques for mobility management.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Mobility management is a scheme employed to ensure service-continuity for a user equipment (UE) through handovers and beam switching during UE mobility, for examples, as the UE moves across different coverage areas of a radio access network. In some cases, during a handover, the selection of a target cell and/or candidate cell is performed based on radio measurements without considering other information (such as a past UE mobility pattern or traffic). Thus, it can be challenging to perform a handover without a failure as trial and error is effectively used to find a suitable target cell. A machine learning (ML) model may be used to predict a UE trajectory and/or a handover target or candidates to improve the performance of UE mobility operations. For certain wireless communications systems, it may not be established what type of information is exchanged as assistance information between the wireless communications devices for ML-based UE mobility prediction. Accordingly, the accuracy of the ML-based UE mobility prediction, and thus, the performance of a handover, may depend on input data without assistance information.

Aspects of the present disclosure provide various types of assistance information that can be exchanged between wireless communications devices. In certain aspects, a wireless communications device (e.g., a UE and/or network entity) may obtain assistance information for target or candidate cell or beam prediction, for prediction of certain communication failure event(s), and/or for measurement event prediction. The techniques for mobility management via assistance information described herein may enable improved wireless communication performance, such as reduced latencies, interruptions, packet losses, handover failures, premature handovers, and/or ping-ponging between network entities.

One aspect provides a method for wireless communications by an apparatus. The method includes obtaining assistance information associated with user equipment (UE) mobility; predicting one or more candidate communication links for a communication link modification based at least in part on the assistance information; and communicating with a wireless communications device based at least in part on the one or more candidate communication links.

Another aspect provides a method for wireless communications by an apparatus. The method includes obtaining assistance information associated with UE mobility; predicting an occurrence of one or more communication failure events based at least in part on the assistance information; and communicating with a wireless communications device based at least in part on the predicted occurrence of the one or more communication failure events.

Another aspect provides a method for wireless communications by an apparatus. The method includes obtaining assistance information associated with UE mobility; predicting an occurrence of one or more channel measurement events that trigger channel measurement based at least in part on the assistance information; and modifying a channel measurement procedure based on the predicted occurrence of the one or more channel measurement events.

Another aspect provides a method for wireless communications by an apparatus. The method includes predicting at least an interruption time associated with a communication link modification; and communicating with a wireless communications device based at least in part on the interruption time.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 illustrates an example artificial intelligence (AI) architecture that may be used for AI-enhanced wireless communications.

FIG. 6 illustrates an example AI architecture of a first wireless device that is in communication with a second wireless device.

FIG. 7 illustrates an example artificial neural network.

FIG. 8 depicts an example of UE mobility in a wireless communications network.

FIG. 9 depicts a process flow for communicating assistance information.

FIG. 10 depicts a method for wireless communications.

FIG. 11 depicts another method for wireless communications.

FIG. 12 depicts another method for wireless communications.

FIG. 13 depicts another method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for mobility prediction with assistance information.

Certain wireless communications systems (e.g., a 5G NR system and/or any future wireless communications system) may employ artificial intelligence (AI) to perform various operations, such as channel state feedback (CSF) estimation, CSF encoding/decoding, beam management, device positioning, user equipment (UE) mobility, etc. UE mobility may involve a UE moving from one position to another position and encountering various communication links (e.g., beam(s), cell(s), and/or cell group(s)) across a radio access network (RAN).

Mobility management is a scheme employed to ensure service-continuity of a UE through handovers and/or beam switching during UE mobility, for example, as the UE moves across different coverage areas of a RAN. As the coverage area of a single network entity decreases, such as for high-frequency communications (e.g., for mmWave communications), the frequency for UE to handover between network entities becomes high, especially for a high-mobility UE (e.g., a UE traveling in a vehicle). In addition, for applications (e.g., extended reality and/or cloud gaming) characterized with stringent performance specifications (e.g., quality of service (QoS) parameters such as reliability, latency, etc.), the quality of experience may be sensitive to the handover performance, such as unsuccessful handovers. An unsuccessful handover can cause packet losses and/or extra delay during the mobility period, which can cause QoS specifications to not be met for packet-drop-intolerant and low-latency applications. In some cases, during a handover, the selection of the target cell and/or candidate cell(s) is performed based on the radio measurements without considering other information (such as a past UE mobility pattern or traffic). Thus, it can be challenging to perform a handover procedure without a failure. A machine learning (ML) model may be used to predict a UE trajectory and/or a handover target or candidates cells or beams.

Technical problems for ML-based UE mobility prediction may include, for example, exchanging effective assistance information between wireless communication devices for ML model training, ML model inference, and/or ML model performance monitoring. Assistance information may refer to supplemental information for ML-based operations (e.g., training inference, and/or performance monitoring) communicated from a wireless communications device to another wireless communications device, for example, from a UE to a network entity, from a network entity to a UE, and/or from a network entity to another network entity. Assistance information may include certain information (e.g., supplemental conditions, measurements, predictions, etc.) that can be fed as input to the ML model, that can be used for developing ML models for UE mobility prediction, and/or that can be used for determining life cycle management operations (e.g., model activation, deactivation, switching, fallback, or reconfiguration decisions during inference). As an ML model may depend on certain input data, assistance information may supplement the input data and be exchanged between wireless communications devices to enhance the accuracy of the ML model and/or monitor the performance of the ML model. For certain wireless communications systems, it may not be established what type of information is exchanged as assistance information between the wireless communications devices for ML-based UE mobility prediction. Accordingly, the accuracy of the ML-based UE mobility prediction, and thus, the performance of mobility operations, may depend on input data without assistance information.

Aspects described herein may overcome the aforementioned technical problem(s) by providing various types of assistance information that can be exchanged between wireless communications devices. In certain aspects, a wireless communications device (e.g., a UE and/or network entity) may obtain assistance information for target cell prediction, candidate cell prediction, and/or beam prediction. As an example, the assistance information may include a history of data size, throughput, latencies, and/or packet losses encountered for traffic between a UE and a network entity. In certain aspects, the wireless communications device may obtain assistance information for prediction of certain communication failure event(s), such as handover failure, radio link failure, and/or beam failure. In such cases, the assistance information may include the parameters configured for detecting certain communication failure events (such as counters, thresholds, and/or timers). In certain aspects, the wireless communications device may obtain assistance information for measurement event prediction. As an example, the assistance information may include configurations for energy saving modes implemented at certain network entities. In an energy saving mode, a network entity may increase the periodicity of certain reference signal transmission, and thus, the configuration for the energy saving mode may inform a UE of the periodicity to monitor reference signals for cell or beam measurements.

Certain techniques for mobility prediction with assistance information described herein may provide various beneficial technical effects and/or advantages. The techniques for mobility prediction with assistance information may enable improved wireless communication performance, such as reduced power consumption at a UE for cell or beam measurements, reduced latencies for handover or beam switching, reduced communication failure events, and/or increased throughput. The reduced power consumption may be attributable to improved accuracy of measurement event prediction based on assistance information. The measurement event prediction may allow a UE to suspend or reduce the instances of cell or beam measurements. The reduced latencies for handover or beam switching may be attributable to improved accuracy of communication failure event prediction and/or target cell prediction, candidate cell prediction, and/or beam prediction based on assistance information. For example, the assistance information may reduce the occurrence of radio link failure and/or beam failure and the latencies associated with recovery from such failure(s). The increased throughput and/or reduced latencies may be attributable to the assistance information enabling accurate predictions of when a cell or beam is suitable for a handover or beam switch.

The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or other uniform array).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

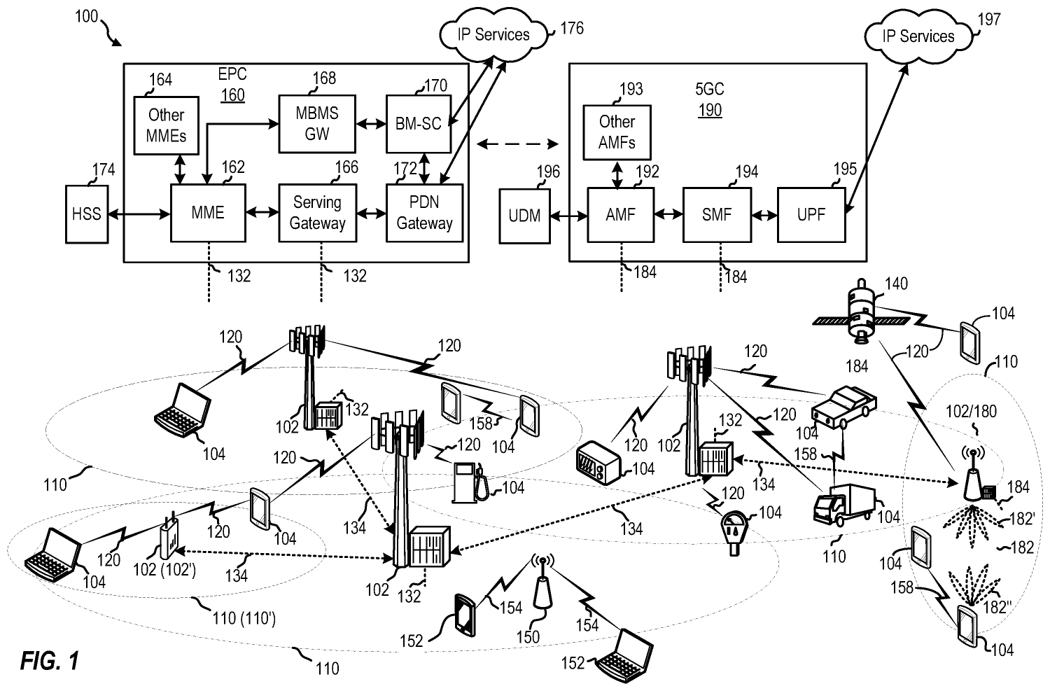

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

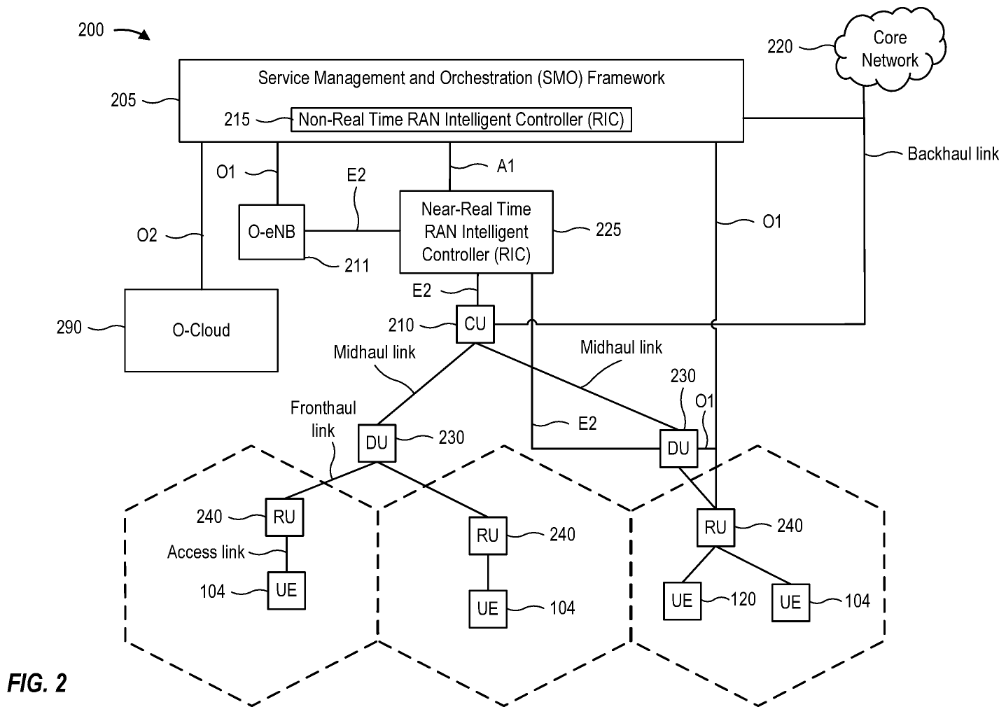

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

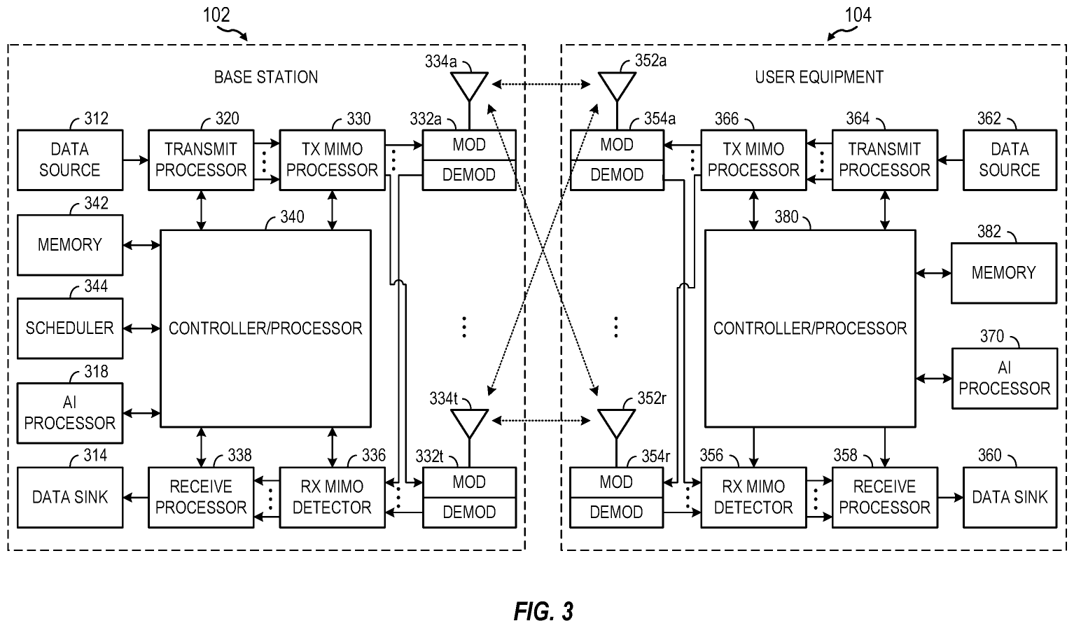

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

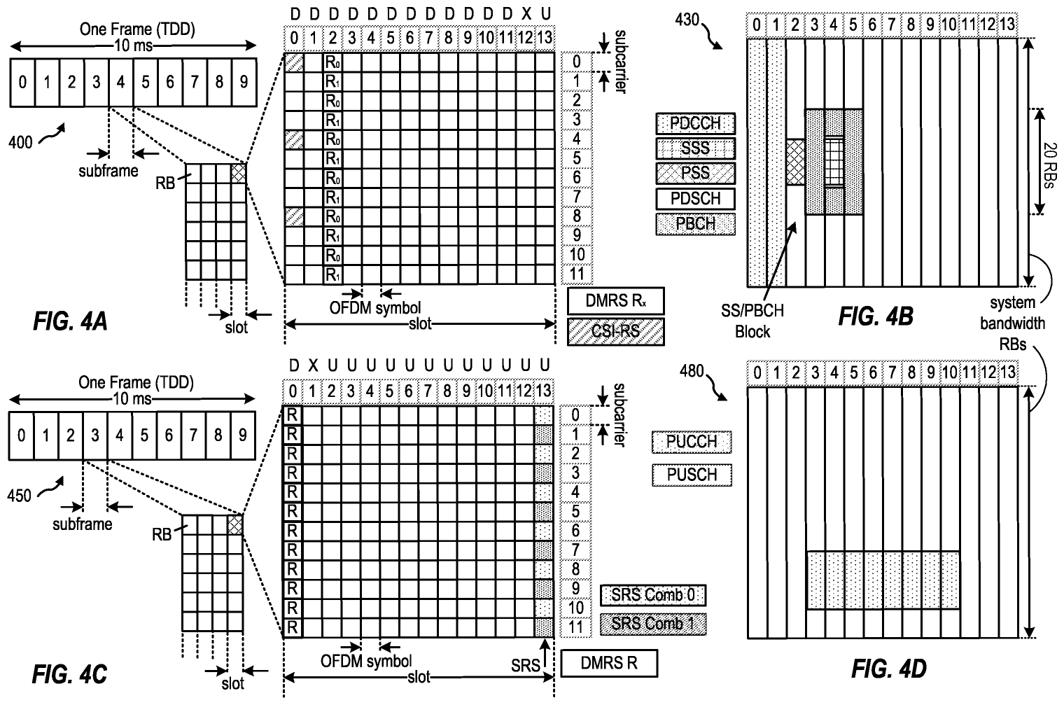

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Artificial Intelligence for Wireless Communications

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

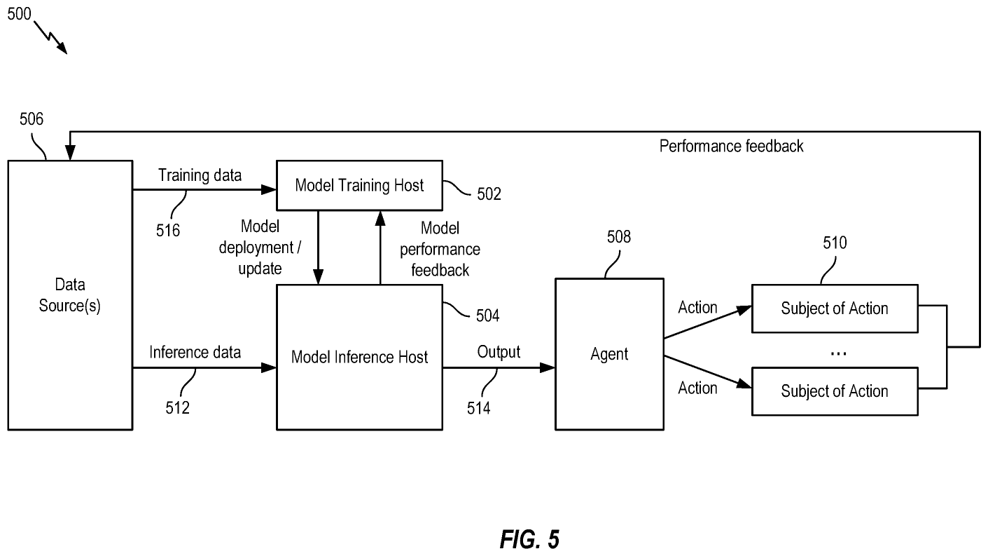

FIG. 5 is a diagram illustrating an example AI architecture 500 that may be used for AI-enhanced wireless communications. As illustrated, the architecture 500 includes multiple logical entities, such as a model training host 502, a model inference host 504, data source(s) 506, and an agent 508. The AI architecture may be used in any of various use cases for wireless communications, such as those listed above.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508.

The agent 508 may be an element or an entity of a wireless communication system including, for example, a radio access network (RAN), a wireless local area network, a device-to-device (D2D) communications system, etc. As an example, the agent 508 may be a user equipment (UE), a base station or any disaggregated network entity thereof including a centralized unit (CU), a distributed unit (DU), and/or a radio unit (RU)), an access point, a wireless station, a RAN intelligent controller (RIC) in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with beam management, the agent 508 may be or include a UE, a DU, or an RU. As another example, if output 514 from model inference host 504 is associated with transmission and/or reception scheduling, the agent 508 may be a CU or a DU.

After the agent 508 receives output 514 from the model inference host 504, agent 508 may determine whether to act based on the output. For example, if agent 508 is a DU or an RU and the output from model inference host 504 is associated with UE mobility, the agent 508 may determine whether to change or modify a serving cell based on the output 514. If the agent 508 determines to act based on the output 514, agent 508 may indicate the action to at least one subject of the action 510. For example, if the agent 508 determines to trigger a handover from a source cell to a target or candidate cell for a communication between the agent 508 and the subject of action 510 (e.g., a UE), the agent 508 may send a handover indication to the subject of action 510 (e.g., a UE). As another example, the agent 508 may be a UE, the output 514 from model inference host 504 may be one or more predicted neighbor cells for a handover. For example, the model inference host 504 may predict neighbor cells for a handover based on a trajectory of the UE. Based on the predicted neighbor cells, the agent 508, such as the UE, may send, to the subject of action 510, such as a BS, a request to perform a handover to at least one of the predicted neighbor cells. In some cases, the agent 508 and the subject of action 510 are the same entity.

The data sources 506 may be configured for collecting data that is used as training data 516 for training an ML model, or as inference data 512 for feeding an ML model inference operation. In particular, the data sources 506 may collect data from any of various entities (e.g., the UE and/or the BS), which may include the subject of action 510, and provide the collected data to a model training host 502 for ML model training. For example, after a subject of action 510 (e.g., a UE) receives a beam configuration from agent 508, the subject of action 510 may provide performance feedback associated with the beam configuration to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, an ML model is deployed at or on a network entity for UE mobility prediction. More specifically, a model inference host, such as model inference host 504 in FIG. 5, may be deployed at or on the network entity for UE mobility predictions including candidate communication link(s) (e.g., candidate cells and/or beams), communication failure event prediction, measurement event prediction, etc.

In some aspects, an ML model is deployed at or on a UE for UE mobility prediction. More specifically, a model inference host, such as model inference host 504 in FIG. 5, may be deployed at or on the UE for candidate communication link(s) (e.g., candidate cells and/or beams), communication failure event prediction, measurement event prediction, etc.

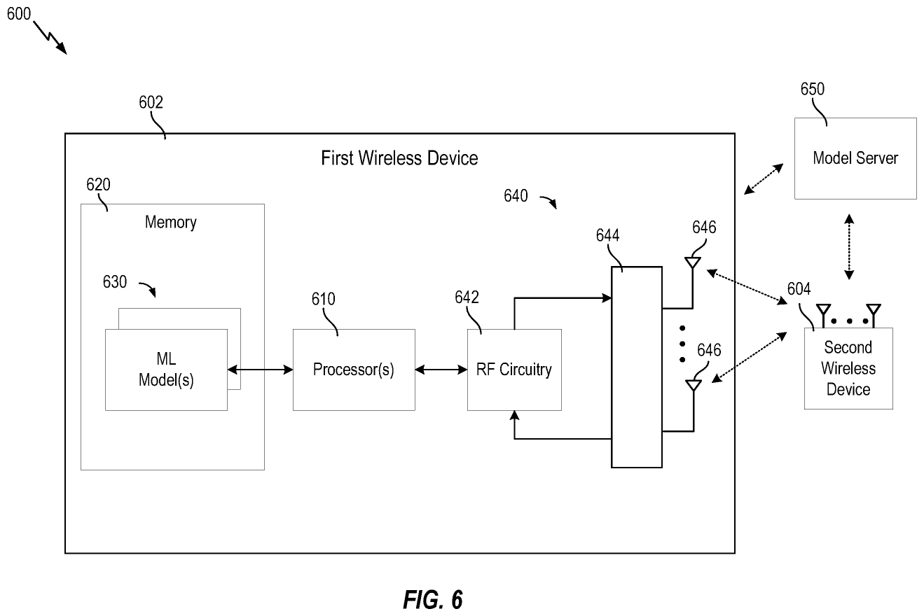

FIG. 6 illustrates an example AI architecture 600 of a first wireless device 602 that is in communication with a second wireless device 604. The first wireless device 602 may be the UE 104 as described herein with respect to FIGS. 1 and 3. Similarly, the second wireless device 604 may be a network entity (or disaggregated entity thereof) as described herein with respect to FIGS. 1 and 2. Note that the AI architecture of the first wireless device 602 may be applied to the second wireless device 604.

The first wireless device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes radio frequency (RF) circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the model inference host 504 of FIG. 5. The ML model 630 may be used to perform any of various AI-enhanced tasks, such as those listed above.

As an example, the ML model 630 may take UE location information (e.g., positioning coordinates over past period of time) as input to predict a trajectory of the UE and handover targets across the trajectory. The input data may include, for example, UE positions over time and serving cell(s) observed at each of the UE positions. The output data may include, for example, a UE trajectory prediction (e.g., latitude, longitude, altitude, over a future period of time). For example, the UE trajectory prediction may correspond to a morning and/or afternoon commute from home to work, or vice versa. Note that other input data and/or output data may be used in addition to or instead of the examples described herein.

In certain aspects, a model server 650 may perform any of various ML model lifecycle management (LCM) tasks for the first wireless device 602 and/or the second wireless device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized machine learning tasks, such as federated learning.

### Example Artificial Intelligence Model

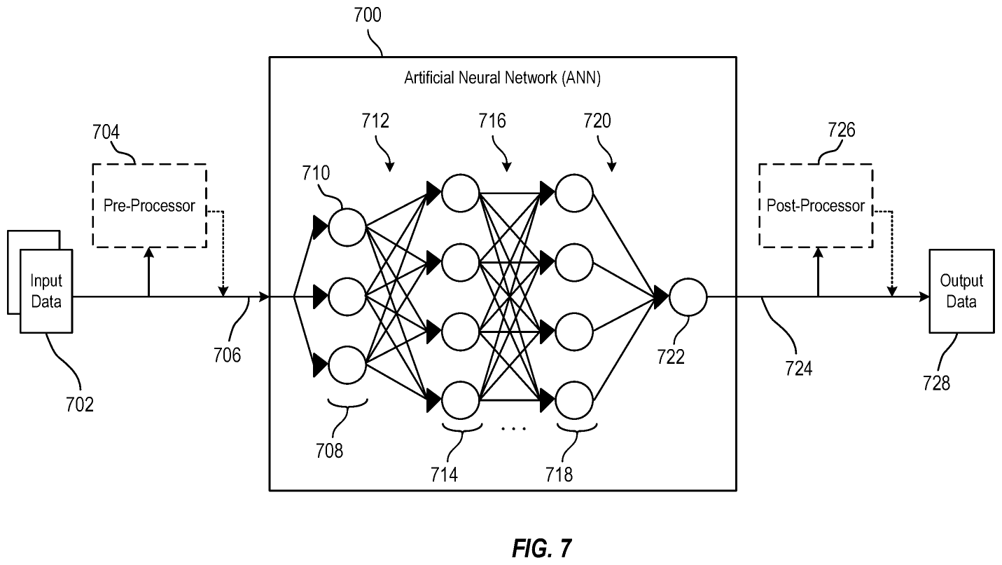

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 506 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Aspects Related to Assistance Information for Mobility Prediction

Aspects of the present disclosure provide various types of assistance information that can be exchanged between wireless communications devices. In certain aspects, a wireless communications device (e.g., a UE and/or network entity) may obtain assistance information for target or candidate cell or beam prediction, for prediction of certain communication failure event(s), and/or for measurement event prediction. The techniques for mobility management via assistance information described herein may enable improved wireless communication performance, such as reduced latencies, packet losses, handover failures, premature handovers, and/or ping-ponging between network entities.

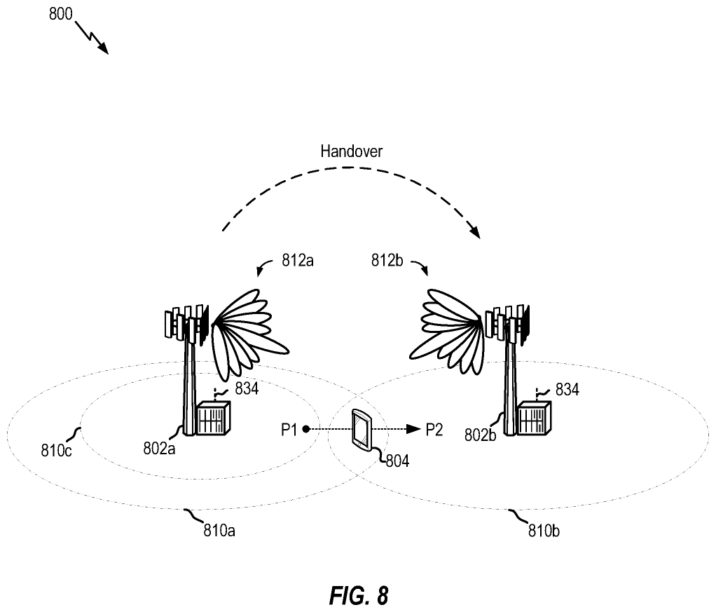

FIG. 8 depicts an example of UE mobility in a wireless communications network 800. In this example, the wireless communication network 800 may include a first network entity 802a having a first coverage area 810a and a second network entity 802b having a second coverage area 810b, which may overlap with the first coverage area 810a. The first network entity 802a may also have a third coverage area 810c. In certain aspects, the first coverage area 810a may form a first cell, the second coverage area 810b may form a second cell, and the third coverage area 810c may form a third cell. The first cell and third cell may form a first cell group, and the second cell may form a second cell group. The first network entity 802a may communicate via a first set of beams 812a, and the second network entity 802b may communicate via a second set of beams 812b.

Due to mobility (e.g., a UE 804 moving from the first coverage area 810a to the second coverage area 810b), the UE 804 may transition from communicating with the first network entity 802a via the first set of beams 812a to communicating with the second network entity 802b via the second set of beams 812b. As an example, the UE 804 may be located at a first position P1 in the first coverage area 810a and/or the third coverage area 810c at a first occasion, and then the UE 804 may move to a second position P2 in the second coverage area 810b at a second, later occasion.

In some cases, the UE 804 may send a measurement report to the first network entity 802a. The measurement report may indicate radio measurements (e.g., signal strengths) associated with the serving cell of the first network entity 802a and neighboring cell(s) of the second network entity 802b. In certain cases, the measurement report may indicate the signal strengths associated certain beam(s) of the serving cell and the neighboring cell(s), such as the first set of beams 812a and/or the second set of beams 812b. Based on the measurement report (e.g., indicating a stronger signal strength associated with radio measurements for the second network entity 802b relative to the first network entity 802a), the first network entity 802a may determine to handover (HO) communications with the UE 804 to the second network entity 802b. The first network entity 802a may be in communication with the second network entity 802b via a backhaul link 834 (e.g., an F1, Xn, and/or NG interface) in order to exchange information for the handover. In the context of a handover, the first network entity 802a may be referred to as a source network entity, which may represent a point of origin for the HO; and the second network entity 802b may be referred to as a target or candidate network entity, which may represent the destination for the handover.

In some cases, the handover may involve a CU/DU handover, such as inter-DU-intra-CU handover and/or inter-CU handover. For example, the handover may involve a handover from a source DU to a target or candidate DU in communication with a common CU. The handover may involve a handover from a source CU to a target or candidate CU. Accordingly, the first network entity 802a and/or the second network entity 802b may be an example of an RU, DU, and/or CU.

With respect to an ML-based UE mobility prediction, an ML model (e.g., the ANN 700 and/or the ML model 630) may be fed input data to predict a UE trajectory (e.g., a prediction of UE positions over time), which may be used to determine candidates for handover target(s) (e.g., beam(s), cell(s), and/or cell group(s)) along the trajectory. For example, the ML model may predict the trajectory of UE 804 to move from P1 to P2, and thus, the trajectory may indicate that the second network entity 802b is available as a handover target when the UE 804 moves within the second coverage area 810b. In some cases, the ML model may generate a prediction of handover target(s) (e.g., beam(s), cell(s), and/or cell group(s)). For example, the ML model may predict that the second network entity 802b is a handover target when the UE 804 moves within the second coverage area 810b.

The input data for ML-based UE mobility prediction may include UE location information (e.g., UE positions over time), radio measurements (e.g., a reference signal received power (RSRP), a reference signal received quality (RSRQ), and/or a signal-to-interference plus noise ratio (SINR)) for serving cell and/or neighboring cell(s), such as associated with UE location information, UE mobility history information, etc. The output data for ML-based UE mobility prediction may include a UE trajectory prediction, a predicted handover target (e.g., beam(s), cell(s), and/or cell group(s)), an estimated arrival time and interval to encounter a handover target, UE traffic prediction, etc.

As further described herein, assistance information may be transferred from a first wireless communications device to a second wireless communications device, and the second wireless communications device may use the assistance information to enhance the accuracy of an ML-based UE mobility prediction. That is, the assistance information may supplement the input data for an ML-based UE mobility prediction described above. As an example, the UE 804 may send, to the first network entity 802a, assistance information for handover target or candidate prediction. The assistance information may include a history of data size, throughput, latencies, and/or packet losses encountered for traffic between the UE 804 and the first network entity 802a and/or between the UE 804 and the second network entity 802b. The traffic history may allow the first network entity 802a and/or the second network entity 802b to configure communication resources that match the service specifications of the traffic history.

Note that the handover illustrated in FIG. 8 is an example of a mobility operation. Aspects of the present disclosure described herein with respect to assistance information for UE mobility predictions may be applied to various types of UE mobility operations including, for example, an Xn based handover, an N2 based handover, lower-layered triggered mobility (LTM), conditional handover, beam selection, beam switch, serving cell modification, serving cell addition, serving cell release, cell group modification, cell group addition, cell group release, etc. A handover may be triggered, for example, due to radio conditions (e.g., in response to a measurement report), load balancing at a network entity, and/or a specific service (e.g., to ensure wireless communications performance that satisfies a QoS specification).

An LTM may refer to a specific type of handover scheme that enables a serving cell change via Layer-1 (e.g., DCI) and/or Layer-2 signaling (e.g., medium access control signaling), while keeping configuration of the upper layers (e.g., RRC configuration(s)) and/or reducing changes of configuration of the lower layers. An LTM-based handover helps reduce the latency, overhead and interruption time during handover. LTM may be performed for intra-DU and/or intra-CU-inter-DU mobility. During LTM, a user plane session may be maintained with the target or candidate cell for intra-DU mobility, without reset, to avoid or minimize packet losses and/or additional latencies.

Assistance information may be used for ML model training, ML model inference, and/or ML model performance monitoring. The assistance information may be or include radio measurements (e.g., RSRP, RSRQ, SINR, etc.), parameters (e.g., counters, thresholds, and/or time intervals that trigger mobility operations), historical performance or statistics information, and/or predictions used for or associated with mobility operations. The assistance information may supplement input data fed to an ML model for UE mobility predictions, the input data comprising any of the information described above.

The assistance information may be transferred from UE to network entity, from network entity to UE, and/or between network entities (e.g., a source network entity and one or more neighboring network entities). The UE may obtain, from a network entity, assistance information via radio resource control (RRC) signaling, medium access control (MAC) signaling, downlink control information (DCI), and/or system information. The UE may send, to a network entity, assistance information via RRC signaling, MAC signaling, and/or uplink control information (UCI).

Note that the network entities, which communicate assistance information, may be any of the disaggregated entities of a base station, such as a DU and/or CU as discussed above. In certain aspects, the assistance information exchanged between network entities may be between a master node (MN) with a master cell group (e.g., one or more serving cells) and a secondary node (SN) with a secondary cell group in a multi-connectivity context. In certain aspects, a first network entity may send assistance information to a second network entity, for example, via a backhaul link (such as the backhaul link 834) and/or any of the communications interfaces described herein with respect to FIGS. 1 and 2, such as a fronthaul link, midhaul link, backhaul link, F1, Xn, E1, NG, etc.

### Aspects Related to Assistance Information for Candidate Communication Link Predictions

In certain aspects, the assistance information may be used to predict or support the prediction of candidate communication link(s) (e.g., handover target(s)) for mobility operations (e.g., handover and/or beam switching). A communication link may include a beam, a cell, and/or a cell group for wireless communications between a UE and a network entity. The assistance information may be used for ML model training, ML model inference, and/or ML model performance monitoring for an ML trained or configured to predict candidate communication link(s).

With respect to an ML model deployed at or on a network entity (e.g., the first network entity 802a), the assistance information may include a mobility history report. The mobility history report may be transferred from a UE to the network entity. The mobility history report may include a list of recently visited primary cells and/or time spent in any cell selection state and/or camped on any cell state. In certain aspects, the mobility history report may include radio resource control (RRC) state information (e.g., a list of recently assigned RRC states), and time spent in each RRC state at a cell and/or beam. The mobility history report may indicate or enable determination of a sequence of connected state mobility associated with visited primary cell(s) or beam(s) for a UE. In certain aspects, a primary serving cell may be or include a primary serving cell (PCell) for a master cell group (MCG) and/or a primary cell for a secondary cell group (e.g., a primary secondary cell group (SCG) cell (PSCell)).

The assistance information may include measurement(s) obtained at a UE and/or network entity. The assistance information may include radio measurement(s) (e.g., Layer-1 and/or Layer-3 RSRP, RSRQ, SINR, etc.) of communication link(s), for example, obtained at a UE. For example, the radio measurement(s) may include measurements(s) of reference signals communicated via certain communication link(s), such as beam(s) and/or cell(s). The radio measurement(s) may include a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER), for example, associated with a reference signal. The radio measurements may include measurements of neighbor cell(s) and/or source cell(s) of a measurement report. In certain aspects, the radio measurements may include measurements of interference at certain communication resource(s) (e.g., time-frequency resource(s)).

In some cases, a specific network entity may perform performing ML model training, such as a CU and/or model server. For example, the DU can provide training data and assistance information to a CU for ML model training. The UE may send, to a first network entity (e.g., a DU), Layer 1 radio measurements, for example, in a Layer 1 measurement report. The first network entity may encode the radio measurements in an RRC format, and the first network entity may send, to a second network entity (e.g., a CU), the encoded radio measurements to facilitate ML model training at the second network entity. The UE may provide assistance information (e.g., Layer 3 radio measurements) to the second network entity.

The assistance information may include UE traffic information, such as UE traffic history, UE traffic patterns, and/or UE traffic statistics associated with (past) communications between the UE and one or more network entities. The UE traffic information may be or include information associated with past traffic communicated via previously visited cell(s) and/or beam(s), for example, along a UE trajectory. The UE traffic information may include a history of data volume (e.g., data size), throughput, delay (e.g., latencies), and/or packet losses (e.g., packet loss ratio or packet loss rate). In certain aspects, the UE traffic information may include traffic statistic(s) over a time period, such as peak value(s), minimum value(s), average value(s), median value(s) etc. over a time period (e.g., past and/or future time period). In certain aspects, the UE traffic information may be or include a historical representation of performance metric(s) for traffic associated with a UE across previously visited communication link(s), such as cell(s) and/or beam(s). For example, the performance metrics(s) for traffic communicated via the previously visited cell(s) and/or beams may include a total data size of the traffic, a throughput of the traffic, a latency of the traffic, and/or a packet loss metric of the traffic. The UE traffic information may be transferred from UE to network entity, network entity to UE, and/or between network entities. The UE traffic information may be used to predict or determine a future UE traffic pattern along a trajectory.

The assistance information may include mobility statistics associated with communications between the UE and one or more network entities. The mobility statistics may include the number of radio link failures, the number of beam failures, the number of handover failures, the number of successful beam switches, and/or the number of successful handovers encountered by a UE over a time period for communications with one or more network entities. The time period may be or include a time period of a UE trajectory or a specific past and/or future time period, such as an hour, day, or week. The mobility statistics may be at a beam level, cell level, and/or cell group level. In certain aspects, the mobility statistics may include any of the counters for management, orchestration and charging operations (e.g., SA5 counters). The mobility statistics may be transferred from UE to network entity, from network entity to UE, and/or between network entities.

The assistance information may include ML-based predictions(s) determined at a UE and/or network entity. The ML-based prediction(s) may include an expected uplink buffer status of a UE at a particular time or after specific time. A prediction for UE traffic (e.g., the expected uplink buffer status) can be provided to a network entity in a Layer 1 and/or Layer 2 message (e.g., a scheduling request) or RRC message (e.g., buffer status). The ML-based prediction(s) may include a prediction of the UE trajectory (e.g., UE position(s), direction(s), orientation(s), velocities, etc. over time). The UE position may include a longitude, latitude, and/or elevation (e.g., height). The ML-based prediction(s) may include a prediction of a state or status associated with a cell and/or cell group (e.g., a secondary cell group). The cell or cell group state or status may be or include an activation or deactivation of a cell or cell group for a UE, for example, at a particular time (such as an arrival time for the UE to be in suitable transmission range of a cell or cell group and/or a departure for the UE to be out of a suitable transmission range of a cell or cell group). The ML-based prediction(s) may include prediction(s) for timing and/or frequency synchronization for candidate cell(s) or beam(s), such as a timing advance prediction and/or a frequency compensation prediction (e.g., a frequency compensation for Doppler effects) for a candidate cell or beam. The ML-based prediction(s) may be transferred from UE to network entity, from network entity to UE, and/or between network entities. In some cases, the ML-based prediction(s) may include a UE mobility prediction (e.g., candidate communication link(s)) determined at a UE and transferred to a network entity. The ML-based prediction(s) may include a UE mobility prediction determined at a network entity and transferred to a UE.

The ML-based prediction(s) may include network energy savings (NES) information associated with one or more network entities. The ML-based prediction(s) an indication or prediction of whether a cell/beam is expected to be in a NES mode at a particular time, predicted start time for the NES mode, a predicted duration for the NES mode (e.g., a duration that the cell/beam will be switched on/off), and/or a cell or beam identifier associated with the NES mode prediction(s). As an example, in an NES mode, a network entity may refrain from using a cell or beam for communications. The cell or beam may effectively be switched off for communications. In some cases, in the NES mode, the network entity may reduce the communications activity of a cell or beam, such as increasing the periodicity for SSB transmission(s) via the cell or beam. The NES mode prediction(s) may indicate whether a candidate beam or cell is available for a handover or beam switch. For example, if a beam or cell is indicated as being in an NES mode for a particular time period, an ML model may be trained or configured to refrain from selecting such a beam or cell as a target for handover or beam switch during the time period for the NES mode.

In certain aspects, assistance information may be used to determine or predict candidate cell(s) and/or a target cell for LTM. For example, a network entity may use the assistance information to determine or predict the target cell conveyed via a LTM switch command, and the network entity may send, to a UE, the LTM switch command that indicates a target cell for a UE to switch to for communications. Assistance information may be transferred to a CU or DU for LTM. The assistance information may be or include a target beam or cell reported by a UE, CU, DU, and/or secondary node. The assistance information may be or include cell or beam load prediction(s) or historical information, such as predictions (or historical information) for traffic load or channel usage via the cell or beam. As an example, a DU may determine or predict cell or beam load information (e.g., traffic load and/or channel usage via the cell and/or beam), and the DU may send the cell or beam load information to a CU that determines the candidate cell(s) and/or the target cell for LTM. In certain cases, a CU may send the cell or beam load information to neighbor CU(s), which can forward the information to DU(s) controlled by the neighbor CU(s). Note that LTM is an example of a mobility operation that uses assistance information for UE mobility prediction, and aspects of the present disclosure may be applicable to other mobility operations.

With respect to an ML model deployed at or on a UE (e.g., the UE 804), the assistance information may include any of the information described above with respect to an ML model deployed at or on a network entity. In certain aspects, the assistance information may include a first list (e.g., an allow list) of cells/beams from which the UE is allowed to perform UE mobility prediction(s), and/or a second list (e.g., a deny list) of cell/beams from which the US is prohibited from performing UE mobility prediction(s). A network entity may send assistance information to a UE via unicast, broadcast, multicast, on-demand signaling.

### Aspects Related to Assistance Information for Communication Failure Predictions

In certain aspects, the assistance information may be used to predict or support the prediction of communication failure events or communication abnormalities that occur for communications between a UE and one or more network entities. A communication failure event may be or include a radio link failure, a handover failure, an LTM failure, a beam failure, a serving cell change failure (e.g., including a failure for a conditional serving cell change), a serving cell addition failure (e.g., including a failure for a conditional serving cell addition), a secondary cell failure, a random access failure, etc. A radio link failure may be or include a communication failure for a serving cell and/or a cell group including an MCG and/or SCG. A handover failure may be or include a failure associated with an Xn based handover, an N2 based handover, a conditional handover, dual active protocol stack (DAPS) handover, a conditional handover with multiple SCGs, etc. The prediction of the communication failure events may allow a UE and/or network entity to perform mobility operations that avoid, alleviate, and/or reduce interruptions associated with such failure event(s).

With respect to an ML model deployed at or on a network entity (e.g., the first network entity 802a), the assistance information may include one or more parameters for detection of a communication failure event. For example, the parameter(s) may include quality threshold(s) for radio link failure detection and/or beam failure detection, such as the block error rate (BLER) thresholds for in-sync status (e.g., Qin) or out-of-sync status (e.g., Qout). The parameter(s) may include counter(s) used to track instances of the signal quality (e.g., in terms of the BLER) being below or above the respective thresholds for a cell or beam. The counter(s) may include the N310 counter for out-of-sync indications, N311 counter for in-sync indications, and/or the counter for beam failure instances (BFIs). The parameter(s) may include counter thresholds associated with the counters discussed herein. For example, if the counter for BFI is greater than or equal to a threshold (e.g., beamFailureInstanceMaxCount), the UE may trigger a beam failure recovery. The parameters may include timer(s) that define a time period during which the failure status of communications is evaluated, such as out-of-sync status, in-sync status, serving cell reconfiguration failure, and/or beam failure. The timer(s) may include the timer T310 for out-of-sync status evaluation, the timer T311 for in-sync status evaluation, the timer T304 for serving cell reconfiguration failure, the timer for beam failure detection (e.g., beamFailureDetectionTimer). The parameter(s) may include an indication of whether a timer associated with the one or more communication failure events has expired.

The assistance information may include ML-based predictions(s) determined at a UE and/or network entity. The ML-based prediction(s) may include any of the prediction(s) previously described herein. The ML-based prediction(s) may include an indication (or probability) that the UE is expected to encounter one or more communication failure events. The ML-based prediction(s) may include an identifier of candidate cell or beam that is expected to encounter a failure if the candidate is used a target for a mobility operation (e.g., a handover or beam switch). The ML-based prediction(s) may include identifier for a candidate communication link that is expected to encounter at least one communication failure event when performing a switch from a source communication link to the candidate communication link. The ML-based prediction(s) may include a time at which the communication failure event is expected to occur (e.g., an expected time of the failure). The ML-based prediction(s) may include an indication of a cause for the communication failure event. The ML-based prediction(s) may include an indication a timing advance for the candidate communication link. The ML-based prediction(s) may include a prediction of one or more conditions for performing a conditional handover or conditional serving cell modification are not expected to be satisfied (e.g., a prediction that certain conditions for triggering a conditional handover or conditional serving cell modification will fail to be satisfied). In some cases, the ML-based prediction(s) may include a UE mobility prediction (e.g., a prediction of communication failure event) determined at a UE and transferred to a network entity. The ML-based prediction(s) may include a UE mobility prediction determined at a network entity and transferred to a UE.

In certain aspects, the assistance information may include radio measurement(s), for example, as discussed above.

With respect to an ML model deployed at or on a UE (e.g., the UE 804), the assistance information may include any of the information described above with respect to an ML model deployed at or on a network entity. In certain aspects, the assistance information may include prediction(s) for timing and/or frequency synchronization for candidate cell(s) or beam(s), such as a timing advance prediction and/or a frequency compensation prediction (e.g., a frequency compensation for Doppler effects) for a candidate cell or beam.

In certain aspects, the assistance information may include one or more UE requested values of one or more parameters for detection of a communication failure event, such as any of the parameters discussed above. As an example, the UE may send, to a network entity, a request for failure detection parameters to be set to certain values. The UE may provide preferred timer values for any of the timer(s) T310, T312, T304, and/or T316. The UE may select the timer value(s) based on UE mobility prediction(s), such as a prediction of communication failure event.

### Aspects Related to Assistance Information for Measurement Event Predictions

In certain aspects, the assistance information may be used to predict or support the prediction of measurement event(s) that trigger certain radio measurement(s), channel measurement(s), and/or reference signal measurement(s). The measurement events may be triggered when radio measurements associated with serving cells and/or neighbor cells satisfy certain threshold(s). The measurement event(s) may be or include the A1 event, which is triggered when a radio measurement (e.g., RSRP, RSRQ, and/or SINR) of a serving cell exceeds a threshold. The measurement event(s) may be or include the A2 event, which is triggered when a radio measurement (e.g., RSRP, RSRQ, and/or SINR) of a serving cell is below a threshold. The measurement event(s) may be or include the A3 event, which is triggered when a radio measurement of a neighbor cell exceeds a radio measurement of a serving cell by an offset. The measurement event(s) may be or include the A4 event, which is triggered when a radio measurement of a neighbor cell exceeds a threshold. The measurement event(s) may be or include the A5 event, which is triggered when a radio measurement of a special cell is below a first threshold, while a radio measurement of a neighbor cell exceeds a second threshold. A special cell refers to the PCell of the MCG or the PSCell of the SCG. The measurement event(s) may be or include the A6 event, which is triggered when a radio measurement of neighbor cell exceeds a radio measurement of a secondary cell by an offset.

The measurement event prediction may allow a UE to adjust measurement quantities and/or intervals. As an example, the measurement event predictions may allow a UE to suspend measurements on a cell or beam until the event is expected to occur. The measurement event predictions may allow a UE to reduce measurement objects or identities. That is, the UE may increase the periodicity at which radio measurements are performed and/or reported to a network entity. The measurement event prediction may indicate to perform a mobility operation, for example, if the measurement event is expected to persist longer than a time-to-trigger (TTT) for a handover.

The assistance information may include NES information associated with one or more network entities, for example, as previously described herein. The assistance information may include ML-based predictions(s) determined at a UE and/or network entity. The ML-based prediction(s) may include any of the prediction(s) previously described herein. The ML-based prediction(s) may include an indication that a NES conditional handover event is expected to occur at a future time.

### Aspects Related to Configurations based on UE Mobility Predictions

In certain aspects, certain wireless communication parameters or operations may be configured based on a UE mobility prediction, such as a predicted interruption time and/or predicted cause for an interruption associated with a mobility operations. For example, the predicted interruption time and/or predicted cause for the interruption may be used to configure RACH resources at a handover target. The predicted interruption time and/or predicted cause for the interruption may be used to select the communication resources (e.g., a bandwidth part) for target cell or beam. The predicted interruption time and/or predicted cause for the interruption may indicate to switch from an uplink carrier to a supplemental uplink carrier for mobility operations. The predicted interruption time and/or predicted cause for the interruption may indicate to perform a mobility operation via contention-free random access resources. The predicted interruption time and/or predicted cause for the interruption may indicate to switch from a RACH-less to a RACH-based mobility operation. The predicted interruption time and/or predicted cause for the interruption may indicate the number of repetitions for certain random access transmissions, such as the preamble transmission and/or MSG3.

### Example Signaling for Assistance Information in a Communications Network

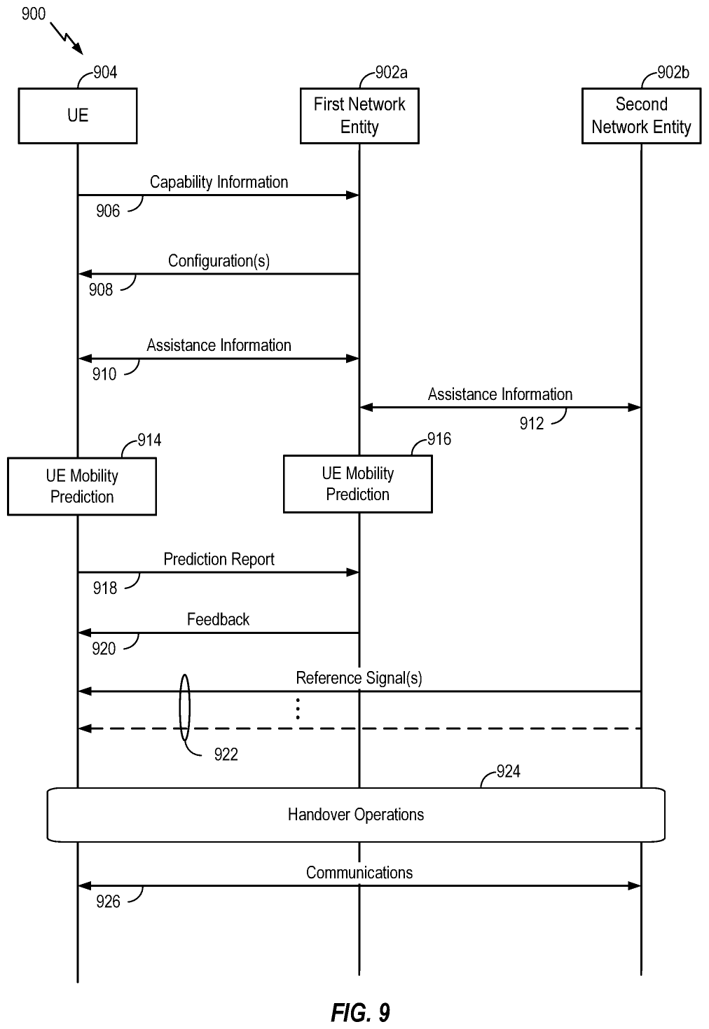

FIG. 9 depicts a process flow 900 for communicating assistance information in a system between a first network entity 902a, a second network entity 902b, and a user equipment (UE) 904. In some aspects, the first network entity 902a and/or the second network entity 902b may be an example of the BS 102 depicted and described with respect to FIGS. 1 and 3 or a disaggregated base station depicted and described with respect to FIG. 2. Similarly, the UE 904 may be an example of UE 104 depicted and described with respect to FIGS. 1 and 3. However, in other aspects, UE 904 may be another type of wireless communications device. The first network entity 902a and/or the second network entity 902b may be another type of network entity or network node, such as those described herein.

At 906, the UE 904 may send, to the first network entity 902a, capability information associated with ML-based UE mobility prediction. The capability information may indicate that the UE 904 is capable of generating a ML-based UE mobility prediction, such as a UE trajectory prediction, a handover target prediction, a candidate communication link prediction, a communication failure event prediction, and/or a measurement event prediction.

At 908, the UE 904 may obtain, from the first network entity 902a, one or more configurations for ML-based UE mobility prediction. The configuration(s) may indicate one or more parameters for ML-based UE mobility prediction, such as probability, confidence, validity, time of encountering, duration of suitability, etc. The configuration(s) may indicate an allow list and/or a deny list of candidate communication links for UE mobility prediction. The configuration(s) may indicate what types of assistance information to provide to a network entity and/or expect from a network entity. The configuration(s) may indicate one or more parameters for prediction reporting to a network entity, such as configuring event-based prediction reporting and/or periodic prediction reporting. The configuration(s) may be communicated via RRC signaling, MAC signaling, DCI, and/or system information.

At 910, the UE 904 may send, to the first network entity 902a, assistance information for determination of UE mobility prediction(s). In some cases, the UE 904 may obtain, from the first network entity 902a, assistance information for determination of UE mobility prediction(s). In certain cases, the UE 904 may obtain, from the first network entity 902a, the assistance information without sending the assistance information to the first network entity 902a, or vice versa. The assistance information may include any of the information described herein. In some cases, the assistance information may be or include information specific to the type of mobility prediction, such as a candidate communication link, communication failure event, and/or measurement event. As an example, the assistance information may include traffic history associated with the UE 904 for communications between the UE 904 and the first network entity 902a and/or between the UE 904 and the second network entity 902b. Such traffic history may enhance a handover target prediction as the traffic history may allow the first network entity 902a and/or the second network entity 902b to allocate communication resources during handover operations that satisfy the specifications associated with the traffic history.

At 912, the first network entity 902a may obtain, from the second network entity 902b, assistance information determination of UE mobility prediction(s). In some cases, the first network entity 902a may send, to the second network entity 902b, assistance information for determination of UE mobility prediction(s). In certain cases, the first network entity 902a may send, to the second network entity 902b, assistance information for determination of UE mobility prediction(s) without the first network entity 902a obtaining assistance information from the second network entity 902b, or vice versa. The assistance information may include any of the information described herein.

At 914, the UE 904 may generate a UE mobility prediction, for example, as discussed above. The UE mobility prediction may be or include a prediction of candidate communication link(s), a prediction of communication failure event(s), and/or a prediction of measurement event(s). The UE 904 may generate the UE mobility prediction based at least in part on the assistance information obtained at 910. For example, the UE 904 may provide an ML model input data comprising the assistance information and/or other information, which may be or include the input data discussed above. The UE 904 may obtain, from the ML model, output data that comprises an indication of a UE mobility prediction. In certain aspects, the assistance information may supplement the input data for the ML model and provide additional or alternative information associated with the mobility of UE 904.

In certain cases, the assistance information may allow the UE 904 to evaluate the accuracy of the UE mobility prediction and/or the performance of the ML model deployed at the UE 904. For example, suppose the assistance information includes a UE mobility prediction generated at the first network entity 902a (or a model server) using an ML model with better accuracy and/or greater knowledge (e.g., via more training) than the ML model deployed at the UE 904. In some cases, the ML model deployed at the first network entity 902a may have a larger or more robust ANN compared to the ML deployed at the UE 904. Accordingly, the UE 904 may compare its prediction to the UE mobility prediction generated at the first network entity 902a, and the UE 904 may evaluate the performance of its ML model and/or the accuracy of its predictions based on the assistance information.

At 916, the first network entity 902a may generate a UE mobility prediction. The UE mobility prediction may be or include a prediction of candidate communication link(s), a prediction of communication failure event(s), and/or a prediction of measurement event(s). The first network entity 902a may generate the UE mobility prediction based at least in part on the assistance information obtained at 910 and/or 912. For example, the first network entity 902a may provide an ML model input data comprising the assistance information and/or other information, which may be or include the input data discussed above. The first network entity 902a may obtain, from the ML model, output data that comprises an indication of a UE mobility prediction. Note that, in some cases, the second network entity 902b may generate a UE mobility prediction.

At 918, the UE 904 may send, to the first network entity 902a, a prediction report that indicates the UE mobility prediction generated at 914, such as a handover target prediction, a communication failure event prediction, and/or a measurement event prediction. The prediction reporting may be periodic or triggered by an event, such as a probability of a prediction exceeding a threshold, a confidence associated with the prediction, etc.

At 920, the UE 904 may obtain, from the first network entity 902a, feedback associated with the prediction report. The feedback may indicate the accuracy and/or error associated with the prediction. The feedback may be implicit and/or explicit. In certain aspects, the feedback may be or include a handover command, beam switch command, LTM command, a serving cell change, a serving cell addition, a serving cell release, etc. For example, a handover command that matches the UE mobility prediction generated at the UE 904 may implicitly indicate that the UE mobility prediction is accurate.

At 922, the UE 904 may obtain, from the second network entity 902b, reference signal(s) at certain measurement occasion(s), for example, based on a measurement event prediction. The UE 904 may obtain radio measurements for the reference signal(s). The reference signal(s) may include an SSB, CSI-RS, DM-RS, and/or any other suitable reference signal. As an example, the measurement event prediction may trigger the UE 904 to obtain radio measurements associated with the second network entity 902b. In some cases, the measurement event prediction may indicate to adjust the periodicity at which the UE 904 obtains the radio measurements. In certain cases, the UE 904 may suspend certain radio measurements based on the measurement event prediction. The measurement event prediction may enable the UE 904 to reduce the power consumed at performing radio measurements.

At 924, the UE 904 performs a handover, for example, based on the UE mobility prediction determined at 914 and/or 916. As an example, the UE 904 and/or the first network entity 902a may determine a handover target based on the UE mobility prediction. The UE mobility prediction may indicate the handover target. The UE mobility prediction may indicate that the UE is expected to encounter communication failure event(s) for other handover candidates. The UE mobility prediction may indicate a measurement event associated with triggering a handover to the handover target. The accuracy of the UE mobility prediction may be enhanced due to the assistance information exchanged at 910 and/or 912. Accordingly, the handover may be performed with reduced latency and/or packet losses due to the assistance information. In certain cases, a handover failure and/or ping-ponging may be avoided via the assistance information.

At 926, the UE 904 communicates with the second network entity 902b. For example, the handover operations may enable the UE 904 to maintain service continuity via a cell or beam of the second network entity 902b.

Note that the handover illustrated in FIG. 9 is an example of a mobility operation, and other mobility operations may be performed based on assistance information for ML-based UE mobility prediction(s). Note that the operations and signaling illustrated in FIG. 9 is described herein to facilitate an understanding of assistance information, and aspects of the present disclosure may be performed in various manners via alternative or additional signaling and/or operations.

### Example Operations for Communicating Assistance Information

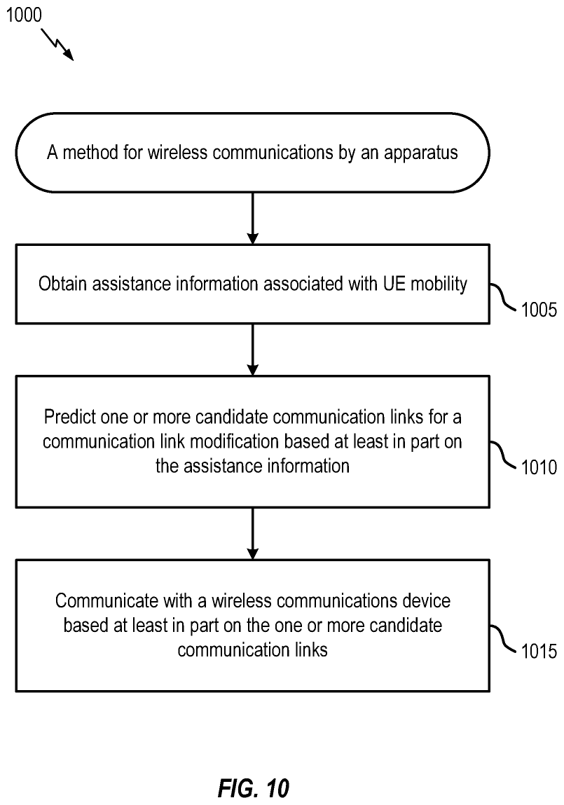

FIG. 10 shows a method 1000 of wireless communications by an apparatus, such as UE 104 of FIGS. 1 and 3, BS 102 of FIGS. 1 and 3, or a disaggregated base station discussed with respect to FIG. 2.

Method 1000 begins at block 1005 with obtaining assistance information associated with UE mobility.

Method 1000 then proceeds to block 1010 with predicting one or more candidate communication links for a communication link modification based at least in part on the assistance information. In certain aspects, the one or more candidate communication links comprise one or more of: a set of candidate cells or a set of candidate beams.

Method 1000 then proceeds to block 1015 with communicating with a wireless communications device based at least in part on the one or more candidate communication links. In certain aspects, block 1015 includes switching from communicating via a source communication link to at least one of the one or more candidate communication links.

In certain aspects, the assistance information comprises a mobility history report associated with a UE. In certain aspects, the mobility history report comprises: one or more RRC states assigned to the UE over a time period and, for each of the one or more RRC states, a duration the UE spent in a respective RRC state.

In certain aspects, the assistance information comprises one or more measurements obtained at a UE and/or one or more network entities. The measurement(s) may include radio measurement(s), reference signal measurement(s), and/or interference measurement(s).

In certain aspects, the assistance information comprises one or more performance metrics for communication traffic associated with a UE. In certain aspects, the one or more performance metrics comprise one or more of: a total data size of the communication traffic, a throughput of the communication traffic, a latency of the communication traffic, or a packet loss metric of the communication traffic.

In certain aspects, the assistance information comprises one or more of: a number of radio link failures over a time period, a number of beam failures over the time period, a number of handover failures over the time period, a number of successful beam switches over the time period, or a number of successful handovers over the time period.

In certain aspects, the assistance information comprises one or more of: an expected uplink buffer status associated with a UE; a prediction of one or more velocity, direction, orientation, or elevation (or height) of the UE; a prediction of a cell and/or a cell group status for the UE (e.g., an activation or deactivation state or status of a cell and/or cell group for the UE at an arrival time or departure time); or a timing advance prediction for at least one candidate communication link of the one or more candidate communication links. In certain aspects, the prediction of the cell group status may be for a secondary cell group (SCG).

In certain aspects, the assistance information comprises one or more of: an indication of whether a candidate communication link of the one or more candidate communication links is expected to be in an energy saving mode or an active mode at a particular time; an indication of a start time for the energy saving mode of the candidate communication link; an indication of a duration for the energy saving mode of the candidate communication link; an indication of a duration for the active mode of the candidate communication link; or an identifier for the candidate communication link.

In certain aspects, the assistance information comprises a traffic load associated with a candidate communication link of the one or more candidate communication links. In certain aspects, the communication link modification may include an LTM operation.

In certain aspects, the assistance information comprises a set of candidate communication links from which the one or more candidate communication links are selected for prediction.

In certain aspects, method 1000 further includes predicting an interruption time associated with the communication link modification. In certain aspects, method 1000 further includes adjusting one or more parameters for communications with the wireless communications device based on the interruption time; wherein block 1015 includes communicating with the wireless communications device based on the one or more parameters.

In certain aspects, block 1010 includes: providing input data to a ML model, wherein the input data comprises the assistance information; and obtaining, from the ML model, output data comprising an indication of the one or more candidate communication links. In certain aspects, the input data may include other information including UE location information, UE mobility history information, radio measurements, etc.

In certain aspects, the wireless communications device comprises a UE. In certain aspects, the wireless communications device comprises a network entity.

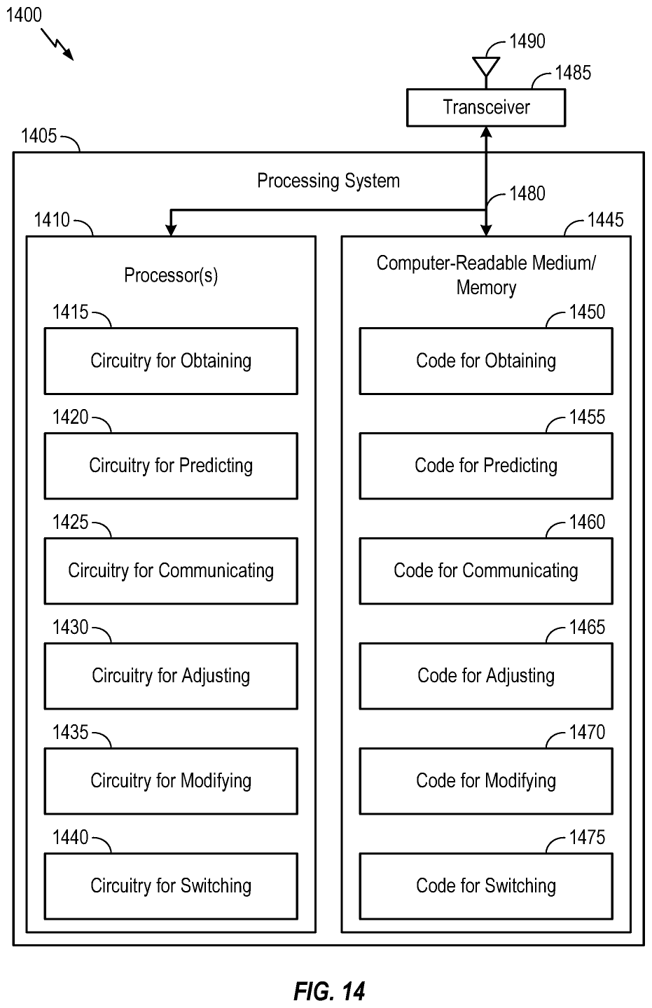

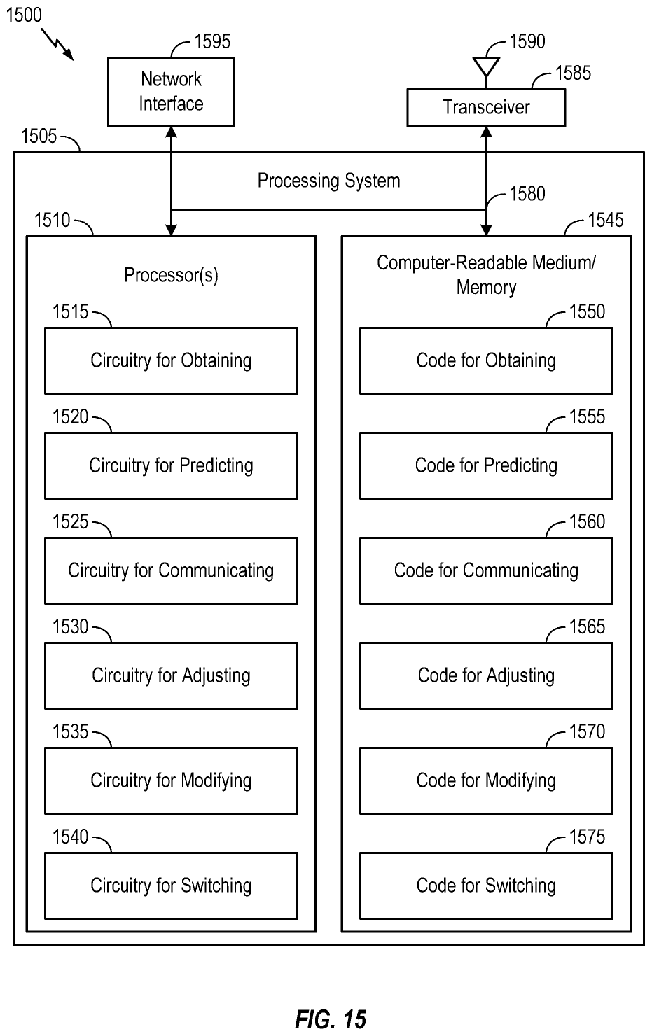

In certain aspects, method 1000, or any aspect related to it, may be performed by an apparatus, such as communications device 1400 of FIG. 14 or communications device 1500 of FIG. 15, which include various components operable, configured, or adapted to perform the method 1000. Communications device 1400 and communications device 1500 are described below in further detail.

Note that FIG. 10 is just one example of a method, and other methods including fewer, additional, or alternative operations are possible consistent with this disclosure.

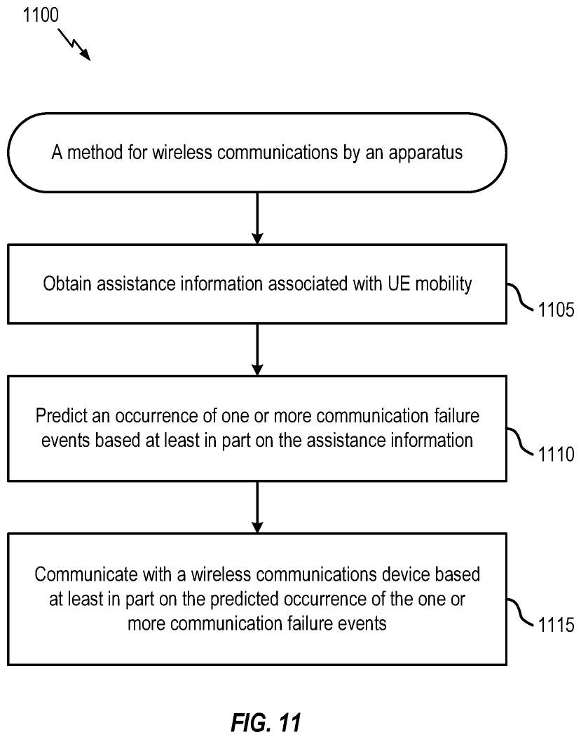

FIG. 11 shows a method 1100 of wireless communications by an apparatus, such as UE 104 of FIGS. 1 and 3, BS 102 of FIGS. 1 and 3, or a disaggregated base station discussed with respect to FIG. 2.

Method 1100 begins at block 1105 with obtaining assistance information associated with UE mobility.

Method 1100 then proceeds to block 1110 with predicting an occurrence of one or more communication failure events based at least in part on the assistance information. In certain aspects, the one or more communication failure events comprise one or more of: a radio link failure, a handover failure, a beam failure, a serving cell change failure, or a serving cell addition failure.

Method 1100 then proceeds to block 1115 with communicating with a wireless communications device based at least in part on the predicted occurrence of the one or more communication failure events. In certain aspects, block 1115 includes switching from communicating via a source communication link to at least one target communication link in response to the predicted occurrence of the one or more communication failure events. In certain aspects, block 1115 includes refraining from switching to communicating via at least one candidate communication link based on the predicted occurrence of the one or more communication failure events being associated with the at least one candidate communication link.

In certain aspects, the assistance information comprises one or more parameters for detection of the one or more communication failure events. In certain aspects, one or more parameters comprise one or more of: one or more first quality thresholds for radio link failure detection; one or more second quality thresholds for beam failure detection; one or more first counters for radio link failure detection; one or more second counters for beam failure detection; one or more first timers for radio link failure detection; one or more second timers for beam failure detection; one or more third timers for serving cell reconfiguration failure; an indication of whether a timer associated with the one or more communication failure events has expired; or one or more reference signal measurements.

In certain aspects, the assistance information comprises one or more of: an indication that a UE is expected to encounter at least one event of the one or more communication failure events; an identifier for a candidate communication link that is expected to encounter at least one event of the one or more communication failure events when performing a switch from a source communication link to the candidate communication link; an indication of a time for the predicted occurrence of the one or more communication failure events; an indication of a cause for the one or more communication failure events; an indication of a timing advance for the candidate communication link; or an indication that one or more conditions for performing one or more of a conditional handover or conditional serving cell modification are not expected to be satisfied.

In certain aspects, the assistance information comprises a prediction that at least one event of the one or more communication failure events is expected to occur.

In certain aspects, the assistance information comprises one or more requested values of one or more parameters for detection of the one or more communication failure events.

In certain aspects, method 1100 further includes predicting an interruption time associated with the occurrence of one or more communication failure events. In certain aspects, method 1100 further includes adjusting one or more parameters for communications with the wireless communications device based on the interruption time; wherein block 1115 includes communicating with the wireless communications device based on the one or more parameters.

In certain aspects, block 1110 includes: providing input data to a ML model, wherein the input data comprises the assistance information; and obtaining, from the ML model, output data comprising an indication of the occurrence of one or more communication failure events.

In certain aspects, the wireless communications device comprises a UE. In certain aspects, the wireless communications device comprises a network entity.

In certain aspects, method 1100, or any aspect related to it, may be performed by an apparatus, such as communications device 1400 of FIG. 14 or communications device 1500 of FIG. 15, which include various components operable, configured, or adapted to perform the method 1100. Communications device 1400 and communications device 1500 are described below in further detail.

Note that FIG. 11 is just one example of a method, and other methods including fewer, additional, or alternative operations are possible consistent with this disclosure.

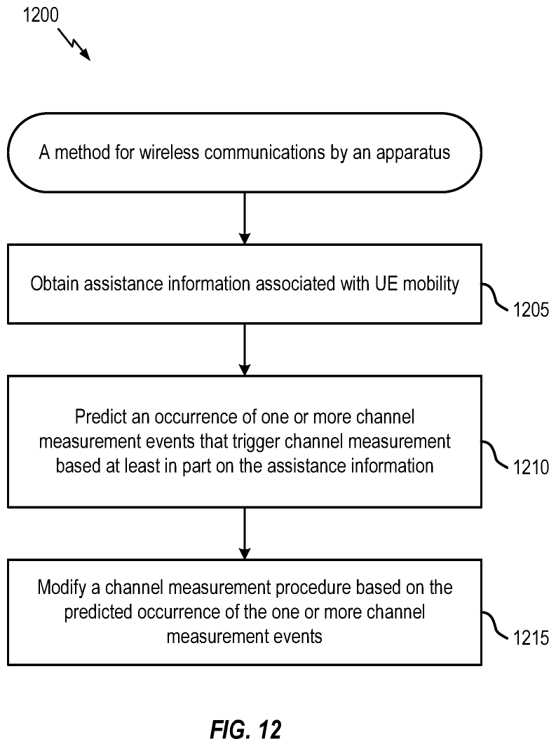

FIG. 12 shows a method 1200 of wireless communications by an apparatus, such as UE 104 of FIGS. 1 and 3, BS 102 of FIGS. 1 and 3, or a disaggregated base station discussed with respect to FIG. 2.

Method 1200 begins at block 1205 with obtaining assistance information associated with UE mobility.

Method 1200 then proceeds to block 1210 with predicting an occurrence of one or more channel measurement events that trigger channel measurement based at least in part on the assistance information. In certain aspects, the one or more channel measurement events comprise an event that occurs when a channel measurement satisfies a threshold. In certain aspects, the channel measurement is associated with a serving cell or a neighbor cell. In certain aspects, the channel measurement comprises one or more a RSRP, a RSRQ, or a SINR.

Method 1200 then proceeds to block 1215 with modifying a channel measurement procedure based on the predicted occurrence of the one or more channel measurement events. In certain aspects, block 1215 includes refraining from obtaining channel measurements associated with a communication link based on the predicted occurrence of the one or more channel measurement events.

In certain aspects, method 1200 further includes switching from communicating via a source communication link to at least one target communication link based on the predicted occurrence of the one or more channel measurement events.

In certain aspects, the assistance information comprises one or more of: an indication of whether a conditional handover is expected to be triggered at a first time; an indication of whether a candidate communication link is expected to be in an energy saving mode or an active mode at a second time; an indication of a start time for the energy saving mode of the candidate communication link; an indication of a duration for the energy saving mode of the candidate communication link; an indication of a duration for the active mode of the candidate communication link; an identifier for the candidate communication link; or an indication of a timing advance for the candidate communication link.

In certain aspects, block 1210 includes: providing input data to a ML model, wherein the input data comprises the assistance information; and obtaining, from the ML model, output data comprising an indication of the occurrence of one or more channel measurement events.

In certain aspects, the apparatus comprises a UE. In certain aspects, the apparatus comprises a network entity.

In certain aspects, method 1200, or any aspect related to it, may be performed by an apparatus, such as communications device 1400 of FIG. 14 or communications device 1500 of FIG. 15, which include various components operable, configured, or adapted to perform the method 1200. Communications device 1400 and communications device 1500 are described below in further detail.

Note that FIG. 12 is just one example of a method, and other methods including fewer, additional, or alternative operations are possible consistent with this disclosure.

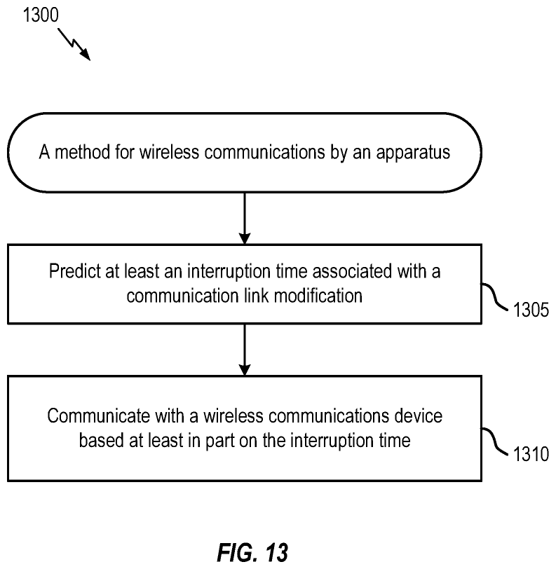

FIG. 13 shows a method 1300 of wireless communications by an apparatus, such as UE 104 of FIGS. 1 and 3, BS 102 of FIGS. 1 and 3, or a disaggregated base station discussed with respect to FIG. 2.

Method 1300 begins at block 1305 with predicting at least an interruption time associated with a communication link modification.

Method 1300 then proceeds to block 1310 with communicating with a wireless communications device based at least in part on the interruption time.

In certain aspects, method 1300 further includes adjusting one or more parameters for communications with the wireless communications device based on the interruption time; wherein block 1310 includes communicating with the wireless communications device based on the one or more parameters. In certain aspects, the one or more parameters comprise one or more of: one or more random access channel resources for a target communication link; one or more communication resources for the target communication link; a number of repetitions for random access communications.

In certain aspects, block 1310 includes performing the communication link modification via one or more contention free random access resources.

In certain aspects, block 1310 includes switching from performing the communication link modification without a random access procedure to performing the communication link modification via a random access procedure.

In certain aspects, block 1310 includes switching from performing the communication link modification via a first uplink channel to performing the communication link modification via a second uplink channel different from the first uplink channel.

In certain aspects, the communication link modification comprises one or more of: a handover; a beam switch; a serving cell addition; or a serving cell modification.

In certain aspects, method 1300, or any aspect related to it, may be performed by an apparatus, such as communications device 1400 of FIG. 14 or communications device 1500 of FIG. 15, which include various components operable, configured, or adapted to perform the method 1300. Communications device 1400 and communications device 1500 are described below in further detail.

Note that FIG. 13 is just one example of a method, and other methods including fewer, additional, or alternative operations are possible consistent with this disclosure.

### Example Communications Devices

FIG. 14 depicts aspects of an example communications device 1400. In some aspects, communications device 1400 is a user equipment, such as UE 104 described above with respect to FIGS. 1 and 3.

The communications device 1400 includes a processing system 1405 coupled to a transceiver 1485 (e.g., a transmitter and/or a receiver). The transceiver 1485 is configured to transmit and receive signals for the communications device 1400 via an antenna 1490, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1445 via a bus 1480. In certain aspects, the computer-readable medium/memory 1445 is configured to store instructions (e.g., computer-executable code) that when executed by the one or more processors 1410, enable and cause the one or more processors 1410 to perform the method 1000 described with respect to FIG. 10, or any aspect related to it, including any operations described in relation to FIG. 10; the method 1100 described with respect to FIG. 11, or any aspect related to it, including any operations described in relation to FIG. 11; the method 1200 described with respect to FIG. 12, or any aspect related to it, including any operations described in relation to FIG. 12; and the method 1300 described with respect to FIG. 13, or any aspect related to it, including any operations described in relation to FIG. 13. Note that reference to a processor performing a function of communications device 1400 may include one or more processors performing that function of communications device 1400, such as in a distributed fashion.

In the depicted example, computer-readable medium/memory 1445 stores code for obtaining 1450, code for predicting 1455, code for communicating 1460, code for adjusting 1465, code for modifying 1470, and code for switching 1475. Processing of the code 1450-1475 may enable and cause the communications device 1400 to perform the method 1000 described with respect to FIG. 10, or any aspect related to it; the method 1100 described with respect to FIG. 11, or any aspect related to it; the method 1200 described with respect to FIG. 12, or any aspect related to it; and the method 1300 described with respect to FIG. 13, or any aspect related to it.

The one or more processors 1410 include circuitry configured to implement (e.g., execute) the code stored in the computer-readable medium/memory 1445, including circuitry for obtaining 1415, circuitry for predicting 1420, circuitry for communicating 1425, circuitry for adjusting 1430, circuitry for modifying 1435, and circuitry for switching 1440. Processing with circuitry 1415-1440 may enable and cause the communications device 1400 to perform the method 1000 described with respect to FIG. 10, or any aspect related to it; the method 1100 described with respect to FIG. 11, or any aspect related to it; the method 1200 described with respect to FIG. 12, or any aspect related to it; and the method 1300 described with respect to FIG. 13, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1485 and/or antenna 1490 of the communications device 1400 in FIG. 14, and/or one or more processors 1410 of the communications device 1400 in FIG. 14. Means for communicating, receiving or obtaining may include the transceivers 354, antenna(s) 352, receive processor 358, AI processor 370, and/or controller/processor 380 of the UE 104 illustrated in FIG. 3, transceiver 1485 and/or antenna 1490 of the communications device 1400 in FIG. 14, and/or one or more processors 1410 of the communications device 1400 in FIG. 14. Means for predicting, adjusting, modifying, or switching may include AI processor 370, and/or controller/processor 380 of the UE 104 illustrated in FIG. 3, and/or one or more processors 1410 of the communications device 1400 in FIG. 14.

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to a transceiver 1585 (e.g., a transmitter and/or a receiver) and/or a network interface 1595. The transceiver 1585 is configured to transmit and receive signals for the communications device 1500 via an antenna 1590, such as the various signals as described herein. The network interface 1595 is configured to obtain and send signals for the communications device 1500 via communications link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1545 via a bus 1580. In certain aspects, the computer-readable medium/memory 1545 is configured to store instructions (e.g., computer-executable code) that when executed by the one or more processors 1510, enable and cause the one or more processors 1510 to perform the method 1000 described with respect to FIG. 10, or any aspect related to it, including any operations described in relation to FIG. 10; the method 1100 described with respect to FIG. 11, or any aspect related to it, including any operations described in relation to FIG. 11; the method 1200 described with respect to FIG. 12, or any aspect related to it, including any operations described in relation to FIG. 12; and the method 1300 described with respect to FIG. 13, or any aspect related to it, including any operations described in relation to FIG. 13. Note that reference to a processor of communications device 1500 performing a function may include one or more processors of communications device 1500 performing that function, such as in a distributed fashion.

In the depicted example, the computer-readable medium/memory 1545 stores code for obtaining 1550, code for predicting 1555, code for communicating 1560, code for adjusting 1565, code for modifying 1570, and code for switching 1575. Processing of the code 1550-1575 may enable and cause the communications device 1500 to perform the method 1000 described with respect to FIG. 10, or any aspect related to it; the method 1100 described with respect to FIG. 11, or any aspect related to it; the method 1200 described with respect to FIG. 12, or any aspect related to it; and the method 1300 described with respect to FIG. 13, or any aspect related to it.

The one or more processors 1510 include circuitry configured to implement (e.g., execute) the code stored in the computer-readable medium/memory 1545, including circuitry for obtaining 1515, circuitry for predicting 1520, circuitry for communicating 1525, circuitry for adjusting 1530, circuitry for modifying 1535, and circuitry for switching 1540. Processing with circuitry 1515-1540 may enable and cause the communications device 1500 to perform the method 1000 described with respect to FIG. 10, or any aspect related to it; the method 1100 described with respect to FIG. 11, or any aspect related to it; the method 1200 described with respect to FIG. 12, or any aspect related to it; and the method 1300 described with respect to FIG. 13, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1585, antenna 1590, and/or network interface 1595 of the communications device 1500 in FIG. 15, and/or one or more processors 1510 of the communications device 1500 in FIG. 15. Means for communicating, receiving or obtaining may include the transceivers 332, antenna(s) 334, receive processor 338, AI processor 318, and/or controller/processor 340 of the BS 102 illustrated in FIG. 3, transceiver 1585, antenna 1590, and/or network interface 1595 of the communications device 1500 in FIG. 15, and/or one or more processors 1510 of the communications device 1500 in FIG. 15. Means for predicting, adjusting, modifying, or switching may include the AI processor 318, and/or controller/processor 340 of the BS 102 illustrated in FIG. 3, and/or one or more processors 1510 of the communications device 1500 in FIG. 15.

### Example Clauses

Implementation examples are described in the following numbered clauses:

Clause 1: A method for wireless communications by an apparatus comprising: obtaining assistance information associated with UE mobility; predicting one or more candidate communication links for a communication link modification based at least in part on the assistance information; and communicating with a wireless communications device based at least in part on the one or more candidate communication links.

Clause 2: The method of Clause 1, wherein the one or more candidate communication links comprise one or more of: a set of candidate cells or a set of candidate beams.

Clause 3: The method of any one of Clauses 1-2, wherein communicating with the wireless communications device comprises switching from communicating via a source communication link to at least one of the one or more candidate communication links.

Clause 4: The method of any one of Clauses 1-3, wherein the assistance information comprises a mobility history report associated with a UE.

Clause 5: The method of Clause 4, wherein the mobility history report comprises: one or more RRC states assigned to the UE over a time period and, for each of the one or more RRC states, a duration the UE spent in a respective RRC state.

Clause 6: The method of any one of Clauses 1-5, wherein the assistance information comprises one or more measurements obtained at a UE and/or a network entity.

Clause 7: The method of any one of Clauses 1-6, wherein the assistance information comprises one or more performance metrics for communication traffic associated with a UE.

Clause 8: The method of Clause 7, wherein the one or more performance metrics comprise one or more of: a total data size of the communication traffic, a throughput of the communication traffic, a latency of the communication traffic, or a packet loss metric of the communication traffic.

Clause 9: The method of any one of Clauses 1-8, wherein the assistance information comprises one or more of: a number of radio link failures over a time period, a number of beam failures over the time period, a number of handover failures over the time period, a number of successful beam switches over the time period, or a number of successful handovers over the time period.

Clause 10: The method of any one of Clauses 1-9, wherein the assistance information comprises one or more of: an expected uplink buffer status associated with a UE; a prediction of one or more velocity, direction, orientation, or height of the UE; a prediction of a cell group status for the UE; or a timing advance prediction for at least one candidate communication link of the one or more candidate communication links.

Clause 11: The method of any one of Clauses 1-10, wherein the assistance information comprises one or more of: an indication of whether a candidate communication link of the one or more candidate communication links is expected to be in an energy saving mode or an active mode at a particular time; an indication of a start time for the energy saving mode of the candidate communication link; an indication of a duration for the energy saving mode of the candidate communication link; an indication of a duration for the active mode of the candidate communication link; or an identifier for the candidate communication link.

Clause 12: The method of any one of Clauses 1-11, wherein the assistance information comprises a traffic load associated with a candidate communication link of the one or more candidate communication links.

Clause 13: The method of any one of Clauses 1-12, wherein the assistance information comprises a set of candidate communication links from which the one or more candidate communication links are selected for prediction.

Clause 14: The method of any one of Clauses 1-13, further comprising: predicting an interruption time associated with the communication link modification; and adjusting one or more parameters for communications with the wireless communications device based on the interruption time; wherein communicating with the wireless communications device comprises communicating with the wireless communications device based on the one or more parameters.

Clause 15: The method of any one of Clauses 1-14, wherein predicting one or more candidate communication links comprises: providing input data to a ML model, wherein the input data comprises the assistance information; and obtaining, from the ML model, output data comprising an indication of the one or more candidate communication links.

Clause 16: The method of any one of Clauses 1-15, wherein the wireless communications device comprises a UE.

Clause 17: The method of any one of Clauses 1-16, wherein the wireless communications device comprises a network entity.

Clause 18: A method for wireless communications by an apparatus comprising: obtaining assistance information associated with UE mobility; predicting an occurrence of one or more communication failure events based at least in part on the assistance information; and communicating with a wireless communications device based at least in part on the predicted occurrence of the one or more communication failure events.

Clause 19: The method of Clause 18, wherein the one or more communication failure events comprise one or more of: a radio link failure, a handover failure, a beam failure, a serving cell change failure, or a serving cell addition failure.

Clause 20: The method of any one of Clauses 18-19, wherein communicating with the wireless communications device comprises switching from communicating via a source communication link to at least one target communication link in response to the predicted occurrence of the one or more communication failure events.

Clause 21: The method of any one of Clauses 18-20, wherein communicating with the wireless communications device comprises refraining from switching to communicating via at least one candidate communication link based on the predicted occurrence of the one or more communication failure events being associated with the at least one candidate communication link.

Clause 22: The method of any one of Clauses 18-21, wherein the assistance information comprises one or more parameters for detection of the one or more communication failure events.

Clause 23: The method of Clause 22, wherein one or more parameters comprise one or more of: one or more first quality thresholds for radio link failure detection; one or more second quality thresholds for beam failure detection; one or more first counters for radio link failure detection; one or more second counters for beam failure detection; one or more first timers for radio link failure detection; one or more second timers for beam failure detection; one or more third timers for serving cell reconfiguration failure; an indication of whether a timer associated with the one or more communication failure events has expired; or one or more reference signal measurements.

Clause 24: The method of any one of Clauses 18-23, wherein the assistance information comprises one or more of: an indication that a UE is expected to encounter at least one event of the one or more communication failure events; an identifier for a candidate communication link that is expected to encounter at least one event of the one or more communication failure events when performing a switch from a source communication link to the candidate communication link; an indication of a time for the predicted occurrence of the one or more communication failure events; an indication of a cause for the one or more communication failure events; an indication of a timing advance for the candidate communication link; or an indication that one or more conditions for performing one or more of a conditional handover or conditional serving cell modification are not expected to be satisfied.

Clause 25: The method of any one of Clauses 18-24, wherein the assistance information comprises a prediction that at least one event of the one or more communication failure events is expected to occur.

Clause 26: The method of any one of Clauses 18-25, wherein the assistance information comprises one or more requested values of one or more parameters for detection of the one or more communication failure events.

Clause 27: The method of any one of Clauses 18-26, further comprising: predicting an interruption time associated with the occurrence of one or more communication failure events; and adjusting one or more parameters for communications with the wireless communications device based on the interruption time; wherein communicating with the wireless communications device comprises communicating with the wireless communications device based on the one or more parameters.

Clause 28: The method of any one of Clauses 18-27, wherein predicting the occurrence of one or more communication failure events comprises: providing input data to a ML model, wherein the input data comprises the assistance information; and obtaining, from the ML model, output data comprising an indication of the occurrence of one or more communication failure events.

Clause 29: The method of any one of Clauses 18-28, wherein the wireless communications device comprises a UE.

Clause 30: The method of any one of Clauses 18-29, wherein the wireless communications device comprises a network entity.

Clause 31: A method for wireless communications by an apparatus comprising: obtaining assistance information associated with UE mobility; predicting an occurrence of one or more channel measurement events that trigger channel measurement based at least in part on the assistance information; and modifying a channel measurement procedure based on the predicted occurrence of the one or more channel measurement events.

Clause 32: The method of Clause 31, wherein the one or more channel measurement events comprise an event that occurs when a channel measurement satisfies a threshold.

Clause 33: The method of Clause 32, wherein the channel measurement is associated with a serving cell or a neighbor cell.

Clause 34: The method of Clause 32 or 33, wherein the channel measurement comprises one or more a RSRP, a RSRQ, or a SINR.

Clause 35: The method of any one of Clauses 31-34, wherein modifying the channel measurement procedure comprises refraining from obtaining channel measurements associated with a communication link based on the predicted occurrence of the one or more channel measurement events.

Clause 36: The method of any one of Clauses 31-35, further comprising switching from communicating via a source communication link to at least one target communication link based on the predicted occurrence of the one or more channel measurement events.

Clause 37: The method of any one of Clauses 31-36, wherein the assistance information comprises one or more of: an indication of whether a conditional handover is expected to be triggered at a first time; an indication of whether a candidate communication link is expected to be in an energy saving mode or an active mode at a second time; an indication of a start time for the energy saving mode of the candidate communication link; an indication of a duration for the energy saving mode of the candidate communication link; an indication of a duration for the active mode of the candidate communication link; an identifier for the candidate communication link; or an indication of a timing advance for the candidate communication link.

Clause 38: The method of any one of Clauses 31-37, wherein predicting the occurrence of one or more channel measurement events comprises: providing input data to a ML model, wherein the input data comprises the assistance information; and obtaining, from the ML model, output data comprising an indication of the occurrence of one or more channel measurement events.

Clause 39: The method of any one of Clauses 31-38, wherein the apparatus comprises a UE.

Clause 40: The method of any one of Clauses 31-39, wherein the apparatus comprises a network entity.

Clause 41: A method for wireless communications by an apparatus comprising: predicting at least an interruption time associated with a communication link modification; and communicating with a wireless communications device based at least in part on the interruption time.

Clause 42: The method of Clause 41, further comprising adjusting one or more parameters for communications with the wireless communications device based on the interruption time; wherein communicating with the wireless communications device comprises communicating with the wireless communications device based on the one or more parameters.

Clause 43: The method of Clause 42, wherein the one or more parameters comprise one or more of: one or more random access channel resources for a target communication link; one or more communication resources for the target communication link; a number of repetitions for random access communications.

Clause 44: The method of any one of Clauses 41-43, wherein communicating with the wireless communications device comprises performing the communication link modification via one or more contention free random access resources.

Clause 45: The method of any one of Clauses 41-44, wherein communicating with the wireless communications device comprises switching from performing the communication link modification without a random access procedure to performing the communication link modification via a random access procedure.

Clause 46: The method of any one of Clauses 41-45, wherein communicating with the wireless communications device comprises switching from performing the communication link modification via a first uplink channel to performing the communication link modification via a second uplink channel different from the first uplink channel.

Clause 47: The method of any one of Clauses 41-46, wherein the communication link modification comprises one or more of: a handover; a beam switch; a serving cell addition; or a serving cell modification.

Clause 48: One or more apparatuses, comprising: one or more memories comprising executable instructions; and one or more processors configured to execute the executable instructions and cause the one or more apparatuses to perform a method in accordance with any one of Clauses 1-47.

Clause 49: One or more apparatuses, comprising: one or more memories; and one or more processors, coupled to the one or more memories, configured to cause the one or more apparatuses to perform a method in accordance with any one of Clauses 1-47.

Clause 50: One or more apparatuses, comprising: one or more memories; and one or more processors, coupled to the one or more memories, configured to perform a method in accordance with any one of Clauses 1-47.

Clause 51: One or more apparatuses, comprising means for performing a method in accordance with any one of Clauses 1-47.

Clause 52: One or more non-transitory computer-readable media comprising executable instructions that, when executed by one or more processors of one or more apparatuses, cause the one or more apparatuses to perform a method in accordance with any one of Clauses 1-47.

Clause 53: One or more computer program products embodied on one or more computer-readable storage media comprising code for performing a method in accordance with any one of Clauses 1-47.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain assistance information associated with user equipment (UE) mobility;
predict one or more candidate communication links for a communication link modification based at least in part on the assistance information; and
communicate with a wireless communications device based at least in part on the one or more candidate communication links.

2. The apparatus of claim 1, wherein the one or more candidate communication links comprise one or more of: a set of candidate cells or a set of candidate beams.

3. The apparatus of claim 1, wherein to communicate with the wireless communications device, the one or more processors are configured to cause the apparatus to switch from communicating via a source communication link to at least one of the one or more candidate communication links.

4. The apparatus of claim 1, wherein the assistance information comprises one or more performance metrics for communication traffic associated with a UE.

5. The apparatus of claim 1, wherein the assistance information comprises one or more of: a number of radio link failures over a time period, a number of handover failures over the time period, a number of successful beam switches, or a number of successful handovers over the time period.

6. The apparatus of claim 1, wherein the assistance information comprises one or more of:
an expected uplink buffer status associated with a UE;
a prediction of one or more velocity, direction, orientation, or height of the UE;
a prediction of a cell group status for the UE; or
a timing advance prediction for at least one candidate communication link of the one or more candidate communication links.

7. The apparatus of claim 1, wherein the assistance information comprises one or more of:
an indication of whether a candidate communication link of the one or more candidate communication links is expected to be in an energy saving mode or an active mode at a particular time;
an indication of a start time for the energy saving mode of the candidate communication link;
an indication of a duration for the energy saving mode of the candidate communication link;
an indication of a duration for the active mode of the candidate communication link; or
an identifier for the candidate communication link.

8. The apparatus of claim 1, wherein the assistance information comprises a traffic load associated with a candidate communication link of the one or more candidate communication links.

9. The apparatus of claim 1, wherein the assistance information comprises a set of candidate communication links from which the one or more candidate communication links are selected for prediction.

10. The apparatus of claim 1, wherein:
the one or more processors are configured to cause the apparatus to:
predict an interruption time associated with the communication link modification, and
adjust one or more parameters for communications with the wireless communications device based on the interruption time; and
to communicate with the wireless communications device, the one or more processors are configured to cause the apparatus to communicate with the wireless communications device based on the one or more parameters.

11. The apparatus of claim 1, wherein to predict one or more candidate communication links, the one or more processors are configured to cause the apparatus to:
provide input data to a machine learning (ML) model, wherein the input data comprises the assistance information; and
obtain, from the ML model, output data comprising an indication of the one or more candidate communication links.

12. An apparatus configured for wireless communications, comprising:
one or more memories; and
one or more processors coupled to the one or more memories, the one or more processors being configured to cause the apparatus to:
obtain assistance information associated with user equipment (UE) mobility;
predict an occurrence of one or more communication failure events based at least in part on the assistance information; and
communicate with a wireless communications device based at least in part on the predicted occurrence of the one or more communication failure events.

13. The apparatus of claim 12, wherein the one or more communication failure events comprise one or more of: a radio link failure, a handover failure, a beam failure, a serving cell change failure, or a serving cell addition failure.

14. The apparatus of claim 12, wherein to communicate with the wireless communications device, the one or more processors are configured to cause the apparatus to refrain from switching to communicating via at least one candidate communication link based on the predicted occurrence of the one or more communication failure events being associated with the at least one candidate communication link.

15. The apparatus of claim 12, wherein the assistance information comprises one or more parameters for detection of the one or more communication failure events.

16. The apparatus of claim 12, wherein the assistance information comprises a prediction that at least one event of the one or more communication failure events is expected to occur.

17. The apparatus of claim 12, wherein the assistance information comprises one or more requested values of one or more parameters for detection of the one or more communication failure events.

18. The apparatus of claim 12, wherein:
the one or more processors are configured to cause the apparatus to:
predict an interruption time associated with the occurrence of one or more communication failure events, and
adjust one or more parameters for communications with the wireless communications device based on the interruption time; and
to communicate with the wireless communications device, the one or more processors are configured to cause the apparatus to communicate with the wireless communications device based on the one or more parameters.

19. The apparatus of claim 12, wherein to predict the occurrence of one or more communication failure events, the one or more processors are configured to cause the apparatus to:
provide input data to a machine learning (ML) model, wherein the input data comprises the assistance information; and
obtain, from the ML model, output data comprising an indication of the occurrence of one or more communication failure events.

20. A method for wireless communications, comprising:
obtaining assistance information associated with user equipment (UE) mobility;
predicting one or more candidate communication links for a communication link modification based at least in part on the assistance information; and
communicating with a wireless communications device based at least in part on the one or more candidate communication links.
